(19) United States
(12) Patent Application Publication
(10) Pub. No.: US 2009/0194921 A1
(43) Pub. Date: Aug. 6, 2009

(54) HIGH FORCE CIVIL ENGINEERING DAMPER

(76) Inventors: Tyn Smith, Lakewood, NY (US); Kyle Zimmerman, Albion, PA (US); Donald Russell, Fairview, PA (US)

Correspondence Address: LORD CORPORATION, 111 LORD DRIVE, CARY, NC, 27511, US

(21) Appl. No.: 12/026,353

(22) Filed: Feb. 5, 2008

(51) Int. Cl. F16F 7/00; G05D 19/00

(52) U.S. Cl. 267/141.1; 700/280

(57) ABSTRACT

A civil engineering damper for damping civil engineered structures comprising a damper housing including two dynamic fluid chambers within a piston cylinder and two static fluid chambers straddling the dynamic fluid chambers along an axis of the housing a piston mounted for reciprocation along the axis of the damper housing. A piston web portion divides the piston cylinder into the two dynamic fluid chamber. A restricted passageway through the piston web portion includes an orifice that provides a resistance to fluid flow between the dynamic fluid chambers. The damper also includes regulated passageways between adjacent dynamic and static fluid chambers valved to allow a flow of fluid from the static fluid chambers to the dynamic fluid chambers and check flows of fluid from the dynamic fluid chambers to the static fluid chambers.

### CROSS-REFERENCE TO RELATED APPLICATIONS

None.

### TECHNICAL FIELD OF THE INVENTION

The present invention relates to building and infrastructural systems having low frequency vibrations, and more particularly, to dampers for building and infrastructural systems for damping troublesome, resonant or otherwise undesirable vibrations within the system.

### BACKGROUND OF THE INVENTION

There is a need for civil engineering dampers for damping civil engineered structures. There is a need for civil engineering dampers for damping civil engineered structures including bridges, buildings, towers, man made structures and controlling relative structure motion and a method of accurately and economically damping troublesome motion in civil engineered structures. There is a need for an economically feasible method of damping troublesome motions in civil engineered structures. There is a need for a robust civil engineering damper system and method of making civil engineering dampers. There is a need for an economic civil engineering damper and method for damping civil engineered structures.

### SUMMARY OF THE INVENTION

In an embodiment, the invention comprises civil engineering dampers for engineered systems. The damper preferably provides a damping force greater than 50,000 pounds with a displacement of less than five-hundredths of an inch. The damper preferably includes a damper housing having two dynamic fluid chambers within a piston cylinder and two static fluid chambers straddling the dynamic fluid chambers along an axis of the damper housing. A piston is mounted within the damper housing and reciprocates along the damper housing axis. The piston further includes a piston web portion that divides the piston cylinder into the two dynamic fluid chambers. A restricted passageway is disposed through the piston web portion. The restricted passageway includes a flow restriction which can be an orifice that provides a resistance to fluid flow between the dynamic fluid chambers for regulating a damping force between the piston and the damper housing. The area of the piston web portion exposed to fluid pressure in a dynamic fluid chamber has an area in relation to the cross-sectional area of the orifice of at least 25,000:1. Two regulated passageways are disposed between adjacent dynamic and static fluid chambers. The regulated passageways are valved to allow a flow of fluid from the static fluid chambers to the dynamic fluid chambers and to check flows of fluid from the dynamic fluid chambers to the static fluid chambers. In an embodiment of the invention, the check valve includes a spring and ball mechanism.

The damper housing also includes bearing supports that separate the dynamic and static fluid chambers. Bearings located radially between the bearing supports center the piston as it reciprocates within the damper housing. Restricted passageways between an outer surface of the piston and the bearings provide a resistance to fluid flow between the dynamic fluid chambers and the static fluid chambers to help regulate the damping force between the piston and the damper housing. These restricted passageways help keep the dynamic pressure rise in the static fluid chambers to less than 10 psi even when the pressure in the dynamic fluid chambers rises by more than 2000 psi. The bearings preferably inhibit fluid flow while preferably supporting a substantial side load.

Another restricted passageway is disposed between the piston web portion and the damper housing to provide a resistance to fluid flow between the dynamic fluid chambers. This restricted passageway helps regulate the damping force between the piston and the damper housing.

The damper also includes a transfer passageway between the static fluid chambers for equalizing pressure between the two static fluid chambers, an accumulator within the damper housing for storing a viscous fluid and to accommodate a change in fluid density without causing a significant static pressure change within the damping fluid, a second flow restriction between the accumulator and the transfer passageway or between the accumulator and one of the first or second static fluid chambers, and seals that join the piston to the damper housing. The seals define the static fluid chambers positioned between the seals and the bearing supports. The seals are preferably bonded elastomeric seals.

In an embodiment of the invention, the civil engineering damper for damping civil engineered structures includes a first seal coupled to a damper housing to define a first static fluid chamber containing a viscous fluid and a piston disposed within the damper housing and having a piston web portion. The piston web portion defines a first dynamic fluid chamber and a second dynamic fluid chamber. The damper further includes a restricted passageway through the piston web portion having an opening that provides fluid communication between the first dynamic fluid chamber and the second dynamic fluid chamber. A first regulated passageway is disposed adjacent to the first static fluid chamber and the first dynamic fluid chamber. The first regulated passageway permits a flow of viscous fluid from the first static fluid chamber to the first dynamic fluid chamber and inhibits a flow of damper fluid from the first dynamic fluid chamber to the first static fluid chamber.

In another embodiment of the invention, the invention includes a damper having a damper housing, the damper housing coupled to the first structure, the damper housing including a first seal arranged to form a first static fluid chamber containing viscous fluid and a second seal arranged to form a second static fluid chamber containing viscous fluid. A piston is disposed within the damper housing defining a first dynamic fluid chamber and a second dynamic fluid chamber. The piston is coupled to the second structure and forces the viscous fluid through an orifice between the first dynamic fluid chamber and the second dynamic fluid chamber in response to a relative motion between the first structure and the second structure. The damper includes a first one-way valve between the first dynamic fluid chamber and the first static fluid chamber, wherein the first valve permits fluid flow from the first static fluid chamber to the first dynamic fluid chamber.

In yet another embodiment of the invention, the damper for damping structures includes a damper housing including two dynamic fluid chambers within a piston cylinder and two static fluid chambers straddling the dynamic fluid chambers along an axis of the housing. A piston is mounted for reciprocation along the axis of the damper housing and includes a piston web portion that divides the piston cylinder into the two dynamic fluid chambers. A restricted passageway through the piston web portion provides a resistance to fluid flow between the dynamic fluid chambers for regulating a damping force between the piston and the damper housing. Regulated passageways between adjacent dynamic and static fluid chambers are valved to allow a flow of fluid from the static fluid chambers to the dynamic fluid chambers and to check flows of fluid from the dynamic fluid chambers to the static fluid chambers. The damper provides a damping force greater than 50,000 pounds of force with a displacement less than 0.05 inches.

The invention will now be described in detail in terms of the drawings and the description which follow.

### BRIEF DESCRIPTION OF THE DRAWING FIGURES

FIG. 1 is a perspective view of a high force damper showing an outer wall of a damper housing.

FIG. 2 is a top view of the high force damper.

FIG. 3 is a cross-sectional view of the high force damper taken from lines A-A in FIG. 2 showing a piston and two check valves disposed therein.

FIG. 4 is a cross-sectional view of the high force damper taken from lines B-B in FIG. 2 showing the piston and an orifice disposed in the damper housing.

FIG. 5A is a cross-sectional view of a spring and ball check valve.

FIG. 5B is a cross-sectional view of the check valve showing a flow path of a viscous fluid through the check valve.

FIG. 6 is a schematic view of a flow path of the viscous fluid in the damper.

### DESCRIPTION

At the outset, it should be appreciated that the use of the same reference number throughout the several drawing figures designates a like or similar element. Generally, the present invention relates to a civil engineering damper for damping civil engineered structures comprising a piston reciprocating within a damper housing to dampen low frequency vibrations. For example, the damper may be used in the construction of buildings, bridges, towers and the like. The damper includes dynamic fluid chambers and static fluid chambers wherein fluid flow between the dynamic fluid chambers is restricted to provide a damping force. It should be appreciated that by low frequency vibrations in civil engineering structures, it is meant that the damper is sufficient for buildings preferably having a vibration frequency less than 100 Hz, more preferably less than 10 Hz, and even more preferably less than 1 Hz.

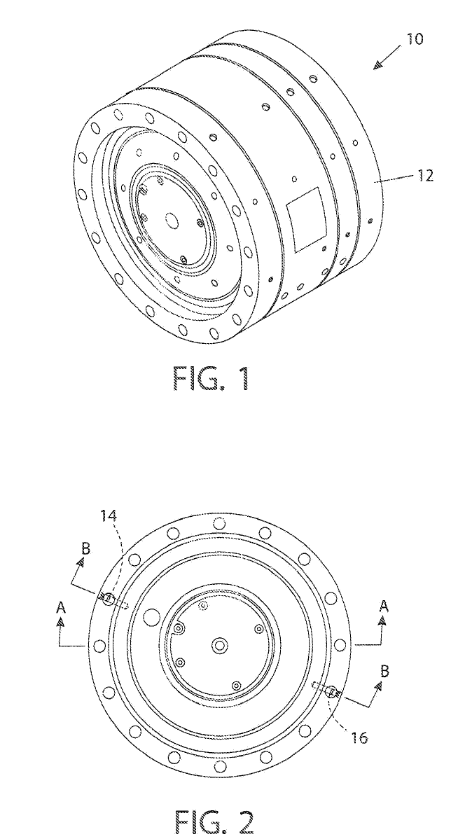

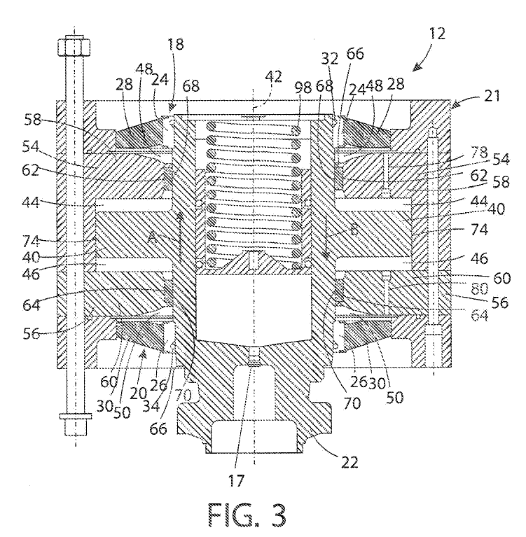

Referring now to the figures, FIGS. 1 and 2 illustrate one embodiment of a damper 10. The damper 10 includes a damper housing 12 having a first and second set of ports 14, 16 which are used to fill the damper housing 12 with damper fluid and for diagnostic testing of the damper, as discussed in more detail supra.

In an embodiment of the invention, the damper housing 12 includes a first end seal 18, a second end seal 20 and a piston cylinder 21. The first end seal 18 and second end seal 20 are coupled to the piston 22. More specifically, inner members 24, 26 are each bonded to an elastomeric member 28, 30 and are disposed on the piston 22 by using an interference fit. O-rings 32, 34 are each disposed between the piston 22 and each of the inner members 24, 26 to prevent each of the seals 18, 20 from leaking in the event the interference fit between the piston 22 and one of the inner members 24, 26 fails. Alternatively, the inner members 24, 26 may be bonded directly to the piston 22 or the elastomeric members 28, 30 may be bonded directly to the piston 22. Although elastomeric seals 18, 20 are shown, it should be appreciated by those having ordinary skill in the art that seals other than elastomeric seals 18, 20 can be used, including but not limited to metal bellow seals, lip seals, hydraulic seals or other dynamic seals. Also, a plurality of means for securing the seals 18, 20 to the piston 22 are possible, including but not limited to, integrating the seals 18, 20 with the piston 22 by machining a bellow seal on the piston 22 or welding a metal bellow seal to the piston 22. The piston 22 is seal-less meaning it has a rigid dynamic interface area that is free of elastomeric deformable and/or non-rigid seal elements. In preferred embodiments, the end seals 18, 20 defining the static fluid chambers 48, 50 are bonded elastomeric seals comprised of elastomeric members 28, 30 bonded with the elastomeric member bond interface ends 24, 26 coupling the piston 22 and the damper housing 12.

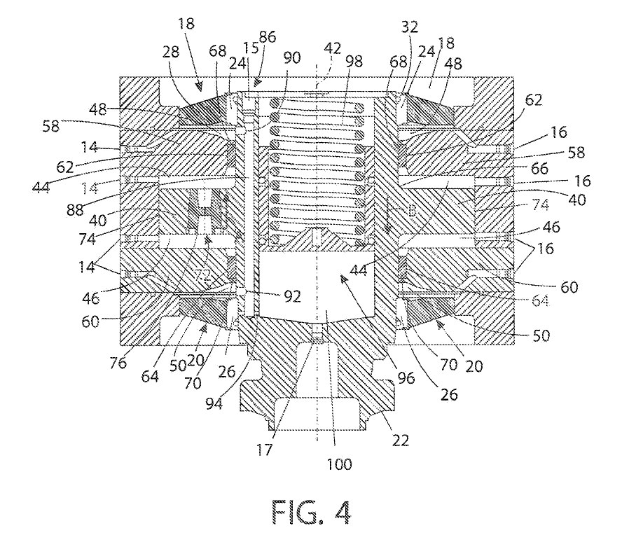

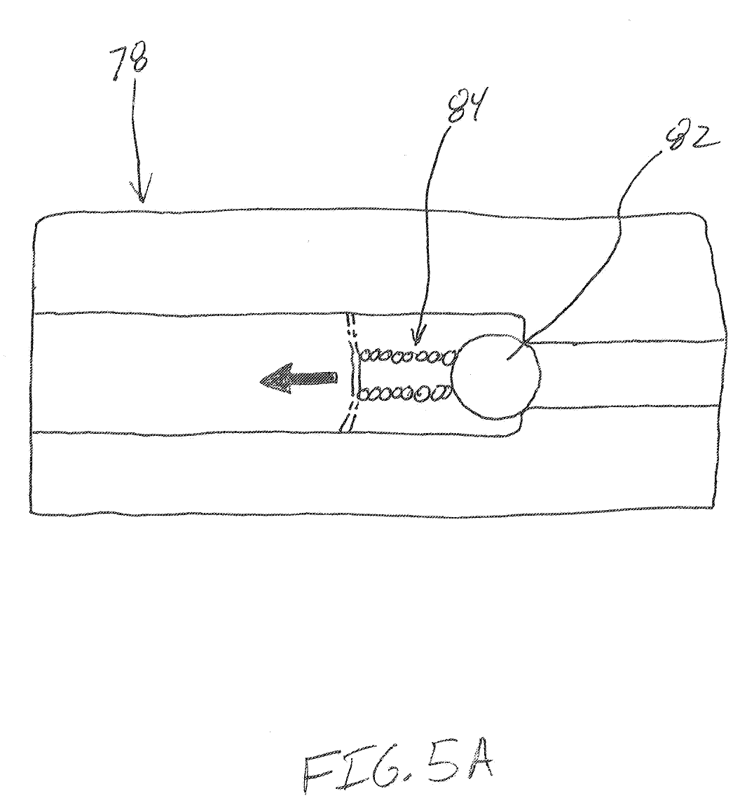

As shown in FIGS. 3 and 4, the piston 22 further includes a piston web portion 40 which is mounted along a longitudinal axis 42 of the damper housing 12. The piston 22 linearly reciprocates along the longitudinal axis 42 and the piston web portion 40 divides the piston cylinder 21 into two dynamic fluid chambers 44, 46. Two static fluid chambers 48, 50 are formed in the damper housing 12 by the first and second end seals 18, 20 and straddle the dynamic fluid chambers 44, 46 along the longitudinal axis 42 of the damper housing 12. It should be understood that by dynamic fluid chambers 44, 46, it is meant that the chambers change in both volume and in pressure level as the piston 22 reciprocates. By static fluid chambers 48, 50 it is meant that the pressure within the chambers does not vary significantly with the piston 22 reciprocation and that the pressure level is generally static in that it rises less than 10 psi.

A viscous fluid, also referred to herein as damping fluid, is contained in the dynamic fluid chambers 44, 46 and the static fluid chambers 48, 50. In a preferred embodiment of the invention, the viscous fluid is a silicon fluid or a hydraulic fluid with a viscosity ranging from about 10 to about 100,000 centipoise. Preferably, the damper fluid has a viscosity less than about 6,000 centipoise, more preferably no greater than about 5,000 centipoise, more preferably no greater than about 2,000 centipoise, and more preferably no greater than about 1,000 centipoise. The viscous fluid maintains liquidity for temperatures ranging from approximately −40° C. to 70° C. Alternate viscous fluids are available to extend the operation to −55° C.

Preferably, the damper 10 includes a plurality of bearing supports 54, 56 providing for an axial movement of the piston 22 and to isolate the pressure rise in the dynamic fluid chambers 44, 46 from the static fluid chambers 48, 50. More specifically, the two bearing supports 54, 56 center the piston 22 and provide the guidance of the piston 22 along the longitudinal axis 42 of the piston 22. That is, the bearing supports 54, 56 each have inwardly extending lateral members 58, 60 and are arranged to facilitate a side load from the piston 22. Bearings 62, 64 are disposed between the bearing supports 54, 56 and the piston 22, wherein the bearings 62, 64 are adhered directly to the bearing supports 54, 56. Preferably, the bearings 62, 64 are metal-less type bearings. More preferably, the bearings comprise of a self-lubricating woven Teflon® fiber and polyester fiber liner supported by a filament wound continuous fiberglass fiber and epoxy resin matrix. Bearings of the type described herein are commercially available from Rexnord Industries, LLC in Downers Grove, Ill. Durability test results show that these bearings generally show less than one-thousandth (0.001) of an inch wear for a simulated life of over twenty (20) years. This wear rate is acceptable to maintain the required flow restriction between the dynamic fluid chambers 44, 46 and static fluid chambers 48, 50. Further, the damper 10 offers damper force stability since the viscous fluid can withstand temperatures ranging from approximately −40° C. to 50° C. In preferred embodiments, the bearings inhibit fluid flow and have less than one-thousandth (0.001) of an inch wear for 20 years of operation life. The damper 10 operation life can include more than one-half billion cycles.

Minimal leakage occurs between an outer perimeter of the piston 66 and the bearings 62, 64, providing restricted passageways 68, 70. Preferably, gaps between the bearings 62, 64 and the outer perimeter of the piston 66 are on the order of three-thousandths (0.003) of an inch or less. Since the bearings 62, 64 are adhered to the bearing supports 54, 56, no leakage or very minimal leakage occurs between the bearings 62, 64 and the bearing supports 54, 56. That is the inwardly extending lateral members 58, 60 separate the dynamic fluid chambers 44, 46 from the static fluid chambers 48, 50, wherein minimal fluid flow is allowed between the dynamic fluid chambers 44, 46 and the static fluid chambers 48, 50 and between the outer perimeter of the piston 66 and the bearings 62, 64. Since the leak path between the bearings 62, 64 and the outer perimeter of the piston 66 is minimal, pressure in the dynamic fluid chambers 44, 46 does not greatly affect the pressure in the static fluid chambers 48, 50. More specifically, for normal operation peak pressure in the dynamic fluid chamber 44, 46 ranges from approximately 1,500 psi to 2,000 psi, however, the pressure in the static fluid chambers 48, 50 range from approximately 15 psi to 25 psi. For short term events, the peak dynamic pressure in the dynamic fluid chambers 44, 46 may be as high as 4,000 psi. Despite the high dynamic pressure changes in the dynamic fluid chambers 44, 46, the dynamic pressure in the static fluid chambers 48, 50 rises less than 10 psi. It should be appreciated by those having ordinary skill in the art that the elastomeric seals 28, 30 cannot withstand significant dynamic pressure, for example above 60 psi, without experiencing increased fatigue issues when operating for hundreds of millions of cycles. Therefore, keeping the dynamic pressure within static fluid chambers 48, 50 below 20 psi, and more preferably below 10 psi improves the longevity of the damper 10.

The dynamic fluid chamber 44 is in fluid communication with the dynamic fluid chamber 46 via a restricted passageway 72, having a flow restriction such as a fluid damping orifice 76. The restricted passageway 72 is disposed through the piston web 40 and provides a resistance to fluid flow between the dynamic fluid chambers 44, 46. Preferably, by regulating the fluid flow between the dynamic fluid chambers 44, 46 the restricted passageway 72 provides the bulk of the damping force. The diameter of the orifice 76 of the restricted passageway can have a diameter range of approximately 0.035-0.042 inches. However, the diameter and length size of the orifice 76 can be easily adjusted to provide for a broader range for other applications of the damper. It should be appreciated that a shorter restricted passageway reduces the need for a more viscous fluid as long as compensation is made by reducing the diameter of the restricted passage. The restricted passageway 72 geometry can contain multiple contractions and expansions.

It should be appreciated that during the flow of the viscous fluid, a vena contracta effect will generally appear within the restricted passageway 72, effectively decreasing the diameter of the passageway and providing further resistance, and therefore, more damping. In the vena contracta region, that is, the area downstream of the restricted passageway 72, the velocity of the viscous fluid will be higher and pressure somewhat lower, causing local cavitations within the vena contracta area, if the local pressure reduces to the vapor pressure of the viscous fluid. For most of the expected piston displacements and frequencies, local cavitation is expected. Operation at higher static pressure levels can reduce the local cavitation effects. While local cavitations can be problematic in some instances, the local cavitations in the vena contracta are not problematic because the formation and collapse of the vapor bubbles occurs in the damper fluid, rather than against the damper housing 12, bearing supports 54, 56 and the piston 22. These local vapor pockets are converted back into a liquid state before the direction of the piston 22 reverses due to the global pressure in the dynamic fluid cavity 44 or 46 being much higher than the vapor pressure of the viscous fluid. Although the restricted passageway 72 is described as an orifice, it should be appreciated by those having skill in the art that any type of flow restriction methods and apparatus can be used. For example, a small aperture can be drilled through the piston web and/or a tube can be extended through an opening into the fluid. Further, the shape of the restricted passageway 72 may be annular or variable and more than one can be incorporated.

In addition to the restricted passageway 72 through the piston web portion 40, fluid flow occurs between a narrow gap 74 between the outer diameter of the piston web 40 and the damper housing 12. More specifically, annular gaps of approximately 0.002 inches to 0.005 inches allow a minimal amount of fluid flow between the piston web portion 40 and the damper housing 12. This fluid flow restriction also contributes to the damping force.

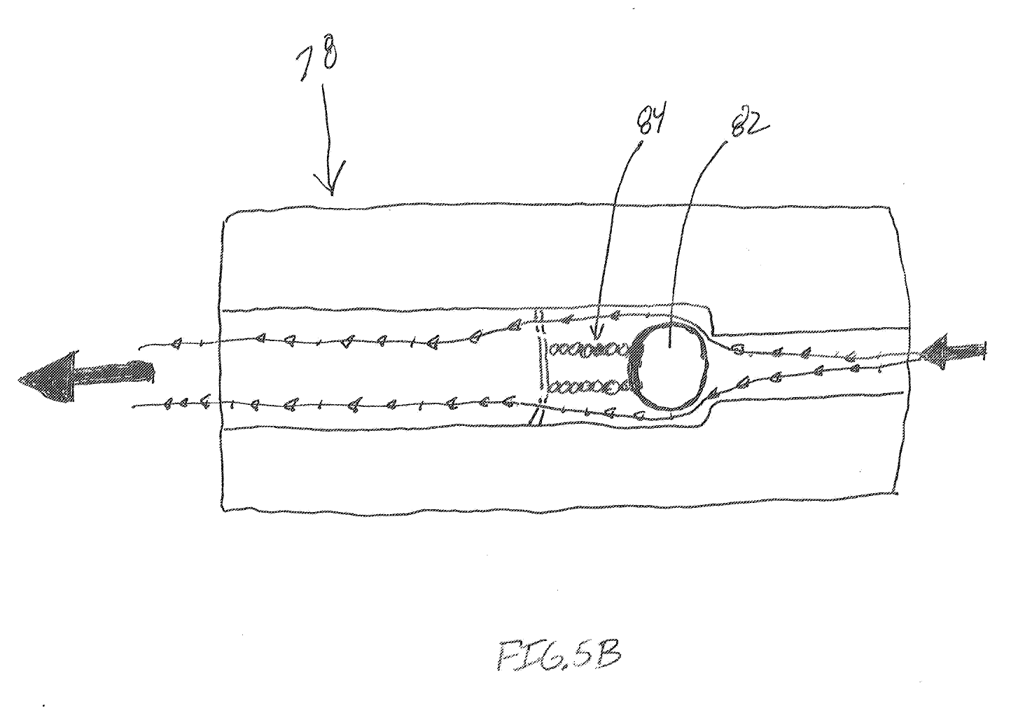

The static fluid chambers 48, 50 are each in fluid communication with the dynamic fluid chambers 44, 46 via regulated passageways 78, 80 that are disposed in the bearing supports 54, 56. The regulated passageways 78, 80 are located at an angular distance from the restricted passageway 72. Preferably, the angular distance between the regulated passageways 78, 80 and the restricted passageway 72 is between approximately 45 degrees and 180 degrees and more preferably between approximately 90 degrees and 180 degrees. The regulated passageways 78, 80 are valved to allow a flow of fluid from the static fluid chambers 48, 50 to the dynamic fluid chambers 44, 46, respectively, and to inhibit flow of fluid from the dynamic fluid chambers 44, 46 to the static fluid chambers 48, 50, respectively. In a preferred embodiment, the regulated passageways 78, 80 comprise check valves, each having a ball 82 and spring 84 as illustrated in FIGS. 5A and 5B. Alternatively, the check valve may comprise a rubber ball or flap. Preferably, the check valves have an OD of approximately 5.5 mm or 7.92 mm and have a cracking pressure of approximately 7 kPa to 15 kPa (1 to 2 psi). Thus, each of the regulated passageways 78, 80 open when the pressure in the corresponding static fluid chamber 48, 50 is greater than the pressure in the corresponding dynamic fluid chamber 44, 46 by at least 1-2 psi. It should be appreciated that the cracking pressure can be modified, if necessary. For example, in a ball and spring valve, the spring stiffness can be increased, requiring a greater cracking pressure to open the valve. Ball and spring check valves of the type described herein are commercially available in a variety of sizes through, for example, Lee Company USA, Westbrook, Conn., part numbers CCRM2550207S, CCRM2550214S, CCRM2800207S, or CCRM2800214S. It should be understood that the check valves 78, 80 could be made of other metal besides stainless steel that these part numbers call for. Further, versions with and without screens could be used, depending on the application. It should be appreciated that the larger diameter check valve, that is, the 7.92 mm OD check valve, provides approximately one-quarter of the flow resistance than the 5.5 mm OD check valve. The maximum working pressure differential in the checked direction is approximately 28 MPa, or 4061 psi.

As shown in FIG. 4, a transfer passageway 86 is disposed within the damper housing 12 permitting fluid communication between the static fluid chambers 48, 50. Preferably, the transfer passageway 86 is a transfer tube 88 and is disposed in the piston 22. The transfer tube 88 includes two channels 90, 92 aligned with the static fluid chambers 48, 50, wherein the first channel 90 connects the transfer tube 88 to the static fluid chamber 48 and the second channel 92 connects the transfer tube 88 to the static fluid chamber 50. The fluid communication between the two static fluid chambers 48, 50 allows pressure between the static fluid chambers 48, 50 to equalize. It should be appreciated that the pressure equalization does not affect the damping performance in the dynamic fluid chambers 44, 46.

The transfer tube 88 includes a flow restriction, such as a connector passageway 94, providing restricted fluid communication between the transfer tube 88 and an accumulator 96 comprising an accumulator piston 98 and a reservoir 100. The accumulator 96 is dynamically isolated from a pressure change, in the first and second dynamic fluid chambers 44, 46, first and second static fluid chambers 48, 50, and the transfer tube 88, by the connector passageway 94. The connector passageway 94 may be, for example, a small diameter tube or a small aperture drilled laterally through the outer perimeter of the piston 22. The accumulator 96 stores the viscous fluid to accommodate thermal changes in the viscous fluid, which expand in higher temperatures. That is, the accumulator piston 98 is spring bias and translates along the longitudinal axis of the piston 22 to accommodate a change in volume. In an alternative embodiment, the accumulator 96 is connected directly to the static fluid chambers 48, 50 rather than to the transfer tube 88. The flow rate between the transfer tube 88 and the accumulator 96 is controlled by adjusting the diameter of the connector passageway 94. For example, the connector passageway 94 may have a diameter in the range of approximately 0.035 inches to 0.050 inches.

Although it is desirable to have a connector passageway 94 with an aperture diameter size that is towards the larger end of the range to prevent clogging as a result of fluid contamination, the diameter size must also remain small enough to provide a low pass frequency filter. Therefore, the accumulator piston 98 will actuate in response to pressure changes in the transfer tube 88 if the damping fluid frequency is low and the aperture diameter size of the connector passageway 94 is large. For accumulator seal durability, it is desirable to have the accumulator piston 98 actuating in response to thermal changes of the viscous fluid, rather than pressure changes in the transfer tube 88, a smaller aperture diameter is preferable for low damping frequencies to prevent the accumulator piston 98 from actuating in response to pressure variations in the transfer tube 88. Similarly, if the damping fluid frequency is higher, a larger diameter connector passageway 94 can be tolerated. In preferred embodiments, the connector passageway 94 has an aperture diameter size D_{AC} and the transfer tube 88 has an aperture diameter size D_{TT}, preferably with D_{AC}<D_{TT}.

The ports 14, 16 are located along the circumference of the damper housing 12 and provide access to the dynamic fluid chambers 44, 46 and the static fluid chambers 48, 50. The ports 14, 16 also permit the measurement of pressure within the dynamic and static fluid chambers 44, 46, 48, 50. The damper 10 is filled with the viscous fluid through ports 16. The ports 16 are larger than the ports 14 to reduce cavitations during the fluid filling and to reduce the filing time. Vapor and air is removed through ports 14. The size of ports 14 and 16 are limited to maintain the structural integrity of the damper housing 12. Additional fill ports 15, 17 are preferably located at the end of the transfer tube 88 and leading into the fluid reservoir 100, respectively. The added access reduces the likelihood of vapor being trapped within the liquid viscous fluid during the filling process and subsequently the damper 10 operation.

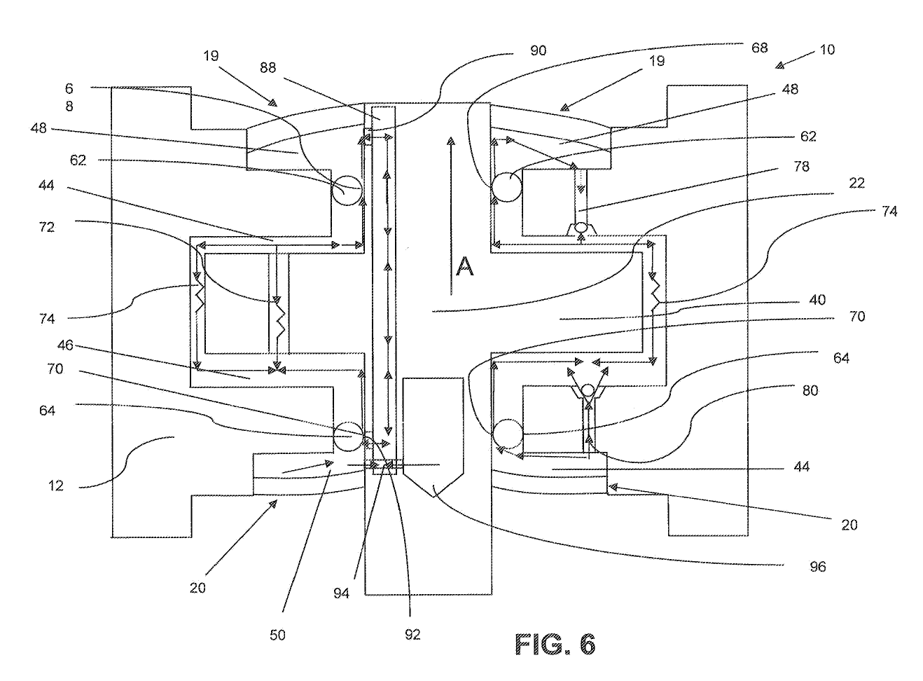

In use, the damper 10 provides damping between a first structure and a second structure of a building, bridge, or like manmade structures. That is, the damper housing 12 is fixedly secured to the first structure. For example, the damper housing 12 can be secured to a surface of the first structure via bolts. The piston 22 is fixedly secured to the second structure of the building, bridge or the like, for example, by bolting the piston 22 to the second structure. Relative motion between the first and second structures, therefore, provides a force acting on the piston 22 relative to the damper housing 12. When the force is acting in a first direction A, as shown in FIG. 6, the force drives the piston 22 along the longitudinal axis, displacing the piston 22 within the damper housing 12. Movement of the piston 22 in direction A reduces the volume in the dynamic fluid chamber 44 and correspondingly increases the volume in dynamic fluid chamber 46. As a result of the volume changes in the dynamic fluid chambers, 44, 46, the dynamic fluid chamber 44 increases in pressure and the dynamic fluid chamber 46 decreases in pressure. This pressure change can range from approximately 1,500 psi to 4,000 psi, and more preferably ranges from approximately 1,500 psi to 2,000 psi. In response, fluid flows from the dynamic fluid chamber 44 to the dynamic fluid chamber 46 via the restricted passageway 72, such as the orifice 76, and via the restricted passageway 74. The area of the piston web 40 exposed to the fluid pressure in one of the dynamic fluid chambers 44, 46 has an area in relation to the area of the orifice 76 of at least 25,000:1. More preferably, the ratio is 68,000:1, wherein the piston area is approximately 66.04 inches squared according to the equation π(10.7²−5.514²)/4 and wherein the orifice area is approximately 0.00096 inches squared according to the equation π(0.035²)/4. This large ratio allows the damper 10 to achieve high damping forces with relatively small piston displacements. It should be appreciated by those having skill in the art that a larger piston area can be achieved by enlarging the diameter of the damper 10 to provide higher damping force. For example, if a higher damping force is desired, the outer diameter of the piston web 40 may be increased from an outer diameter of 9.5 inches to an outer diameter of 10.7 inches.

As discussed infra, a vena contracta effect occurs in the dynamic fluid chamber 46 causing local cavitations in the viscous fluid, rather than against the damper housing 12 and piston 22. Fluid also flows from the dynamic fluid chamber 44 to the static fluid chamber 48 via the restricted passageway 68 between the bearing 62. It should be appreciated that only a minimal amount of fluid, if at all, will flow between the bearing 62 and the outer perimeter of the piston 66. Since the elastomeric seal 28 is coupled to the piston 22, the elastomeric seal 28 can flex to allow the piston 22 to actuate and to confine the viscous liquid within the damper housing 12. Thus, the static fluid chamber 48 will increase in volume. The static fluid chamber 50, however, will corresponding decrease in volume by a similar amount. To equalize the pressure in the static fluid chambers 48, 50, fluid can flow through the channel 90 into the transfer tube 88 and into the static fluid chamber 50 via channel 92. Flow in the opposite direction through the transfer tube 88 can also occur depending upon the volume changes of the static fluid chambers 48, 50 relative to the fluid dynamics of the rest of the system. A minimal amount of fluid, if at all, can flow between the static fluid chamber 50 and the dynamic fluid chamber 46. Further, fluid will flow from static fluid chamber 50 to dynamic fluid chamber 46 via the check valve 80. By allowing fluid flow from the static fluid chamber 50 to the dynamic fluid chamber 46, gross cavitations in the dynamic fluid chambers 44, 46 are avoided. That is, the check valve 80 allows fluid communication between the dynamic fluid chamber 46 and the static fluid chamber 50 when the static fluid chamber 50 has a pressure differential more than 1-2 psi higher than the neighboring dynamic fluid chamber 46. A higher or lower differential pressure before valve actuation can be used for many applications. It should be understood that the second structure can drive the piston along the longitudinal axis in a second direction B providing fluid communication between the restricted passageways 68, 70, and 74, regulated passageways 78, 80, dynamic fluid chambers 44, 46 and static fluid chambers 48, 50 to be reversed.

As a result of having the check valve 80 (and 78 in the reverse direction) pressure in the dynamic fluid chambers 44, 46 does not reach the vapor pressure of the damping fluid and the damper 10 is able to effectively operate at a lower static pressure level. Thus, a high force civil engineering damper 10 is achieved which provides a damping force greater than 50,000 pounds with a displacement of less than 0.05 inches. Preferably, the damping force can be in the range of approximately 50,000 pounds to 450,000 pounds and more preferably the peak damping force is approximately 320,000 pounds.

It should be appreciated that there exists an effective aperture size of the restricted passageways 68, 70, and 74 and the regulated passageways 78, 80 to provide a damper 10 with a damping force that is greater than 50,000. More specifically, the effective aperture size of the regulated passageways 78, 80 disposed between the dynamic fluid chambers 44, 46 and static fluid chambers 48, 50 in the bearing supports 54, 56 has an effective aperture size that is larger than the effective aperture size of the restricted passageway 68, such as the orifice 76 connecting the dynamic fluid chambers 44, 46.

Those skilled in the art will recognize that modifications may be made in the method and apparatus described herein without departing from the true spirit and scope of the invention which accordingly are intended to be limited solely by the appended claims.

1. A civil engineering damper for damping civil engineered structures comprising:
a damper housing including a first dynamic fluid chamber and a second dynamic fluid chamber within a piston cylinder and a first static fluid chamber and a second static fluid chamber straddling the first and second dynamic fluid chambers along an axis of the housing;
a piston mounted for reciprocation along the axis of the damper housing and including a piston web portion that divides the piston cylinder into the first and second dynamic fluid chambers;
a first restricted passageway through the piston web portion having a first flow restriction that provides a resistance to fluid flow between the first and second dynamic fluid chambers for regulating a damping force between the piston and the damper housing, wherein the area of the piston web portion exposed to fluid pressure in either the first and second dynamic fluid chambers has an area in relation to the area of the first flow restriction of at least 25,000:1;
a first regulated passageway between the first dynamic fluid chamber and the first static fluid chamber valved to allow a flow of fluid from the first static fluid chamber to the first dynamic fluid chamber and check flows of fluid from the first dynamic fluid chamber to the first static fluid chamber; and
a second regulated passageway between the second dynamic fluid chamber and the second static fluid chamber valved to allow a flow of fluid from the second static fluid chamber to the second dynamic fluid chamber and check flows of fluid from the second dynamic fluid chamber to the second static fluid chamber.

2. The civil engineering damper of claim 1 further comprising a second restricted passageway between the outer diameter of the piston web portion and the damper housing that provides a resistance to fluid flow between the first and second dynamic fluid chambers for regulating a damping force between the piston and the damper housing.

3. The civil engineering damper of claim 1 wherein the damper provides a damping force greater than 50,000 pounds with a displacement of less than five-hundredths of an inch.

4. The civil engineering damper of claim 1 further comprising a transfer passageway between the first and second static fluid chambers for equalizing pressure between the first and second static fluid chambers.

5. The civil engineering damper of claim 4 further comprising an accumulator within the damper housing for storing a viscous fluid and a second flow restriction between the accumulator and the transfer passageway or between the accumulator and one of the first or second static fluid chambers.

6. The civil engineering damper of claim 4 in which the transfer passageway is formed in the piston and includes openings in the piston connecting the first and second static fluid chambers.

7. The civil engineering damper of claim 4 in which the transfer passageway is formed in the damper housing and is in fluid communication with the first and second static fluid chambers via openings.

8. The civil engineering damper of claim 1 in which each of the regulated passageways between the first dynamic fluid chamber and the first static fluid chamber and between the second dynamic fluid chambers and the second static fluid chamber has an effective aperture size larger than an effective aperture size of the first flow restriction connecting the first and second dynamic fluid chambers.

9. The civil engineering damper of claim 5 in which the accumulator is dynamically isolated from a pressure change, in the first and second dynamic fluid chambers, first and second static fluid chambers, and the transfer passageway, by the second flow restriction.

10. The damper of claim 1 in which the damper housing includes bearing supports separating the first and second dynamic fluid chambers from the first and second static fluid chambers, respectively, and bearings located between the bearing supports and the piston for centering the piston for reciprocation within the damper housing.

11. The civil engineering damper of claim 10 further comprising third and fourth restricted passageways between an outer surface of the piston and the bearings providing a resistance to fluid flow between the first dynamic fluid chamber and the first static fluid chamber and between the second dynamic fluid chamber and the second static fluid chamber for regulating a damping force between the piston and the damper housing, wherein a dynamic pressure in the first and second static fluid chambers rises less than 10 psi and wherein pressure in the first and second dynamic fluid chambers rises more than 1500 psi.

12. The civil engineering damper of claim 10 further comprising seals joining the piston to the damper housing and defining the first and second static fluid chambers between the seals and the bearing supports.

13. The civil engineering damper of claim 12 wherein the seals are elastomeric seals.

14. The civil engineering damper of claim 1 in which a force acting on the piston relative to the damper housing in one direction along the axis relatively displaces the piston within the damper housing reducing a volume of one of the dynamic fluid chambers and correspondingly increasing a volume of the other of the dynamic fluid chambers initiating a first flow of fluid through the first, second and third restricted passageways from the reduced volume to the increased volume dynamic fluid chamber and a second flow of fluid through one of the regulated passageways from one of the static fluid chambers to the higher volume dynamic fluid chamber.

15. The civil engineering damper of claim 14 in which the force acting on the piston also results in a third flow of fluid between the first and second static fluid chambers.

16. The civil engineering damper of claim 14 wherein the piston and the damper housing have a rigid dynamic interface area.

17. A civil engineering damper for damping civil engineered structures comprising:
a first seal coupled to a damper housing to define a first static fluid chamber containing a viscous fluid;
a piston including a piston web portion and disposed within the damper housing, the piston web portion defining a first dynamic fluid chamber and a second dynamic fluid chamber;
a first restricted passageway through the piston web portion having an opening that provides fluid communication between the first dynamic fluid chamber and the second dynamic fluid chamber; and
a first regulated passageway disposed adjacent to the first static fluid chamber and the first dynamic fluid chamber, wherein the first regulated passageway permits a flow of viscous fluid from the first static fluid chamber to the first dynamic fluid chamber and inhibits a flow of damper fluid from the first dynamic fluid chamber to the first static fluid chamber.

18. The civil engineering damper of claim 17 further comprising:
a second seal coupled to the damper housing to define a second static fluid chamber containing the viscous fluid; and
a second regulated passageway disposed adjacent to the second static fluid chamber and the second dynamic, wherein the second regulated passageway permits a flow of viscous fluid from the second static fluid chamber to the second dynamic fluid chamber and inhibits a flow of viscous fluid from the second dynamic fluid chamber to the second static fluid chamber.

19. The civil engineering damper of claim 17 wherein the first regulated passageway is a valve arranged to control fluid pressure in the first dynamic fluid chamber and the second regulated passageway is a valve arranged to control fluid pressure in the second dynamic fluid chamber.

20. The civil engineering damper of claim 18 further including a transfer passageway between the first static fluid chamber and the second dynamic fluid chamber for equalizing pressure between the first static fluid chamber and the second static fluid chamber.

21. The civil engineering damper of claim 20 further comprising a reservoir in fluid communication with the transfer passageway and an accumulator disposed within the piston, wherein the accumulator piston actuates in response to a thermal change of the damping fluid.

22. The civil engineering damper of claim 17 wherein low frequency vibrations of the structure drive the viscous fluid through the first restricted passageway to one of the first and second dynamic fluid chambers forming high pressure in the one of the first and second dynamic fluid chambers and lower pressure in the other first or second dynamic fluid chamber.

23. The civil engineering damper of claim 22 wherein localized cavitations occur in the viscous fluid in the first restricted passageway in the other first or second dynamic fluid chamber having lower pressure.

24. The civil engineering damper of claim 22 wherein the low frequency vibrations of the structure are less than 100 Hz.

25. The civil engineering damper of claim 22 wherein the low frequency vibrations of the structure are less than 10 Hz.

26. The civil engineering damper of claim 22 wherein the low frequency vibrations of the structure are less than 1 Hz.

27. The civil engineering damper of claim 17 wherein the civil engineering damper provides damping forces greater than 50,000 lbs of force.

28. The civil engineering damper of claim 17 wherein the regulated passageway includes a valve ball and a valve spring.

29. A damper for damping between a first structure and a structure comprising:
a damper having a damper housing, the damper housing coupled to the first structure, the damper housing including a first seal arranged to form a first static fluid chamber containing viscous fluid and a second seal arranged to form a second static fluid chamber containing viscous fluid,
a piston disposed within the damper housing defining a first dynamic fluid chamber and a second dynamic fluid chamber, wherein the piston is coupled to the second structure and forces the viscous fluid through an first flow restriction between the first dynamic fluid chamber and the second dynamic fluid chamber in response to a relative motion between the first structure and the second structure; and
a first valve between the first dynamic fluid chamber and the first static fluid chamber, the first valve permitting fluid flow from the first static fluid chamber to the first dynamic fluid chamber.

30. The damper of claim 29 wherein the damper housing further includes a first bearing support and a second bearing support separating the dynamic fluid chambers and the static fluid chambers, wherein the first valve is disposed through the first bearing support to permit one-way fluid communication from the first static fluid chamber to the first dynamic fluid chamber and wherein a second valve is disposed through the second bearing support to permit one-way fluid communication from the second static fluid chamber to the second dynamic fluid chamber.

31. The damper of claim 30, wherein the piston includes a first pump face surface area defining a perimeter edge of the first dynamic fluid chamber, a second pump face surface area defining a perimeter edge of the second dynamic fluid chamber, and a piston web portion contiguous to a portion of the bearing supports to provide for an axial movement of the piston when the second structure drives the piston along a longitudinally extending axis.

32. The damper of claim 31, wherein the first valve includes a first valve ball and a first valve spring.

33. A damper for damping structures comprising:
a damper housing including a first dynamic fluid chamber and a second dynamic fluid chamber within a piston cylinder and a first static fluid chamber and a second static fluid chamber straddling the first and second dynamic fluid chambers along an axis of the housing;
a piston mounted for reciprocation along the axis of the damper housing and including a piston web portion that divides the piston cylinder into the first and second dynamic fluid chambers;
a first restricted passageway through the piston web portion having a first flow restriction that provides a resistance to fluid flow between the first and second dynamic fluid chambers for regulating a damping force between the piston and the damper housing;
a first regulated passageway between the first dynamic fluid chamber and the first static fluid chamber valved to allow a flow of fluid from the first static fluid chamber to the first dynamic fluid chamber and check flows of fluid from the first dynamic fluid chamber to the first static fluid chamber; and
a second regulated passageway between the second dynamic fluid chamber and the second static fluid chamber valved to allow a flow of fluid from the second static fluid chamber to the second dynamic fluid chamber and check flows of fluid from the second dynamic fluid chamber to the second static fluid chamber, wherein the damper provides a damping force greater than 50,000 pounds of force with a displacement less than 0.05 inches.

34. The damper of claim 33 wherein the area of the piston web portion exposed to a fluid pressure in either the first or second dynamic fluid chambers has an area in relation to the area of the first flow restriction of at least 25,000:1.

35. The damper of claim 33 further comprising a transfer passageway between the static fluid chambers for equalizing pressure between the first and second static fluid chambers.

36. The damper of claim 35 further comprising an accumulator within the piston for storing a viscous fluid and a second flow restriction between the accumulator and the transfer passageway or between the accumulator and one of the first or second static fluid chambers.

37. The damper of claim 35 in which the transfer passageway is formed in the piston and includes openings in the piston connecting the first and second static fluid chambers.

38. The damper of claim 33 in which each of the regulated passageways between the first dynamic fluid chamber and the first static fluid chamber and between the second dynamic fluid chamber and the second static fluid chamber has an effective aperture size larger than an effective aperture size of the first flow restriction connecting the first and second dynamic fluid chambers.

39. The damper of claim 36 in which the accumulator is dynamically isolated from a pressure change, in the first and second dynamic fluid chambers, first and second static fluid chambers, and the transfer passageway, by the second flow restriction.

40. The damper of claim 33 further comprising a second restricted passageway between the piston web portion and the damper housing that provides a resistance to fluid flow between the first and second dynamic fluid chambers for regulating a damping force between the piston and the damper housing.

41. The damper of claim 40 in which the damper housing includes bearing supports separating the first dynamic fluid chamber from the first static fluid chamber and the second dynamic fluid chamber from the second static fluid chamber and bearings located between the bearing supports and the piston for mounting the piston for reciprocation within the damper housing.

42. The damper of claim 41 further comprising third and fourth restricted passageways between an outer surface of the piston and the bearings providing a resistance to fluid flow between the first dynamic fluid chamber and the first static fluid chamber and between the second dynamic fluid chamber and the second static fluid chamber for regulating a damping force between the piston and the damper housing, wherein pressure in the static fluid chambers rises less than 10 psi and wherein a dynamic pressure in the dynamic fluid chambers rises more than 1500 psi.

43. The damper of claim 41 further comprising bonded elastomeric seals joining the piston to the damper housing and defining the first and second static fluid chambers between the elastomeric seals and the bearing supports.

44. The damper of claim 33 in which a force acting on the piston relative to the damper housing in one direction along the axis relatively displaces the piston within the piston cylinder reducing a volume of one of the dynamic fluid chambers and correspondingly increasing a volume of the other of the dynamic fluid chambers initiating a first flow of fluid through the first and second restricted passageways from the reduced volume to the increased volume dynamic fluid chamber and a second flow of fluid through one of the regulated passageways from one of the static fluid chambers to the increased volume dynamic fluid chamber.

45. The damper of claim 43 in which the force acting on the piston also results in a third flow of fluid between the first and second static fluid chambers.

46. The damper of claim 33 wherein the piston and the damper housing have a rigid dynamic interface area.

47. A method of damping civil engineering structures comprising:
displacing a piston having a piston web portion within a piston cylinder to reduce a volume of a first dynamic fluid chamber and correspondingly increase a volume of a second dynamic fluid chamber;
initiating a first fluid flow from the first dynamic fluid chamber to the second dynamic fluid chamber via a first restricted passageway;
blocking a second fluid flow from the first static fluid chamber to the first dynamic fluid chamber via a first check valve; and
initiating a third fluid flow from the second static fluid chamber to the second dynamic fluid chamber via a second check valve.

48. The method of damping structures of claim 47 further comprising initiating a fourth fluid flow between the first and second static chambers via a transfer passageway.

49. The method of damping structures of claim 47, wherein initiating a first fluid flow from the first dynamic fluid chamber to the second dynamic fluid chamber further includes restricting the first fluid flow between the piston web portion and the piston cylinder.

50. The method of damping structures of claim 47 further comprising restricting a fifth fluid flow from the first dynamic fluid chamber to the first static fluid chamber via a bearing.
